(19) United States
(12) Patent Application Publication
(10) Pub. No.: US 2021/0176519 A1
(43) Pub. Date: Jun. 10, 2021

(54) SYSTEM AND METHOD FOR IN-VIDEO PRODUCT PLACEMENT AND IN-VIDEO PURCHASING CAPABILITY USING AUGMENTED REALITY WITH AUTOMATIC CONTINUOUS USER AUTHENTICATION

(71) Applicant: AUGMENTED AND SEGMENTED MEDIA INTERFACE CORP., Redwood City, CA (US)

(72) Inventor: Sambhab Thapaliya, Atherton, CA (US)

(21) Appl. No.: 17/111,394

(22) Filed: Dec. 3, 2020

Related U.S. Application Data
(63) Continuation-in-part of application No. 17/033,250, filed on Sep. 25, 2020.
Application No. 17/033,250 is a continuation of application No. 16/893,263, filed on Jun. 4, 2020, now Pat. No. 10,827,214.
(60) Provisional application No. 62/944,300, filed on Dec. 5, 2019.
(60) Provisional application No. 62/858,267, filed on Jun. 6, 2019.

(51) Int. Cl. H04N 21/431; H04N 21/466; H04N 21/478

(52) U.S. Cl. CPC H04N 21/4316; H04N 21/4662; G06T 19/006; H04N 21/4667; H04N 21/47815

(57) ABSTRACT

Techniques are provided by which the digital delivery of a viewer-requested video along with the best chosen advertisement for the viewer is improved. These techniques may be particularly suited for the short video industry. An innovative video analytics mechanism and user-behavioral analytics mechanism are provided, with which the best match of an exact product on the video for the particular viewer is advertised on the video, while the viewer is viewing the video. Further, techniques are provided that enable the viewer to purchase the product while still in the video, not having to leave the video or the site to complete the purchase. Further, techniques are provided by which the users and their smartphones are automatically continuously being authenticated.

### CROSS REFERENCE TO RELATED APPLICATIONS

This patent application is a continuation-in-part of U.S. application Ser. No. 17/033,250 filed Sep. 25, 2020, now pending, which is a continuation of U.S. application Ser. No. 16/893,263 filed Jun. 4, 2020, now U.S. patent Ser. No. 10/827,214, issued Nov. 3, 2020, which claims benefit of U.S. provisional patent application Ser. No. 62/858,267, Product Placement and Marketing using Augmented Reality, filed Jun. 6, 2019, the entirety of each of which is incorporated herein by this reference thereto. This patent application claims benefit of U.S. provisional patent application Ser. No. 62/944,300 filed Dec. 5, 2019, the entirety of which is incorporated herein by this reference thereto.

### BACKGROUND OF THE INVENTION

### Technical Field

This invention relates generally to the field of object recognition in computer vision technology and augmented reality technologies. More specifically, this invention relates to a system and method for product placement and marketing using object recognition and augmented reality. Further, this invention relates to automated continuous user authentication on a smartphone.

### Description of the Related Art

Presently, companies provide platforms on which creators may upload their digital videos for viewers to consume. To support their efforts, such companies may allow digital advertisements from third-party vendors to be displayed along with the video. These advertisements might be presented before or after the video is streamed. Worse, the video stream may be interrupted in the middle so that the advertisement is played. In other examples, the advertisement might be played on the screen space with the video, perhaps alongside the video or as a small window overlaying the video. Also, presently, users typically are required to login manually to their devices, such as smartphones, each time they need to authenticate.

### SUMMARY

Techniques are provided by which the digital delivery of a viewer-requested video along with the best chosen advertisement for the viewer is improved. These techniques may be particularly suited for the short video industry. An innovative video analytics mechanism and user-behavioral analytics mechanism are provided, with which the best match of an exact product on the video for the particular viewer is advertised on the video, while the viewer is viewing the video. Further, techniques are provided that enable the viewer to purchase the product while still in the video, not having to leave the video or the site to complete the purchase. Further, techniques are provided by which the users and their smartphones are automatically continuously being authenticated.

### BRIEF DESCRIPTION OF THE DRAWINGS

One or more embodiments of the present invention are illustrated by way of example and not limitation in the figures of the accompanying drawings, in which like references indicate similar elements.

FIG. 1 depicts a screenshot of a video frame in which an interactive video object, an interactive product logo, and an interactive product purchase window in a portion of the video are each presented, in accordance with an embodiment;

FIG. 2 depicts a screenshot of a video frame in which an interactive video object, an interactive product logo, and an interactive product purchase window in a portion of the video are each presented, in accordance with an embodiment;

FIG. 3 depicts a screenshot of a video frame in which an interactive video object, an interactive product logo, and an interactive product purchase window in a portion of the video are each presented, in accordance with an embodiment;

FIG. 4 is a schematic diagram of a high-level architecture of the network environment, in accordance with an embodiment;

FIG. 5 is a schematic diagram of the API Ad matching process and best Ad file delivery process, in accordance with an embodiment;

FIG. 6 depicts a process for analyzing and storing video data, including identifying objects within the video and identifying products within the video, in accordance with an embodiment;

FIG. 7 depicts a process for analyzing user-behavioral data, including identifying objects viewed on videos, in accordance with an embodiment;

FIG. 8 depicts a network environment for when a viewer views the video, in accordance with an embodiment;

FIG. 9 depicts a network environment for during each video upload, in accordance with an embodiment;

FIG. 10 depicts a network environment for API overall workflow, in accordance with an embodiment;

FIG. 11 is a block schematic diagram of a system in the exemplary form of a computer system according to an embodiment;

FIG. 12 is a screenshot 1200 of an e-commerce website on a smartphone, the screenshot showing a list of four video options, shown as circled, that are selectable by the user to activate the corresponding video, in accordance with an embodiment;

FIG. 13 is a screenshot of a cooked dish with an advertiser's company logo and link to a discount super-imposed over the original display of the cooked dish, in accordance with an embodiment;

FIG. 14A is a screenshot of a short video in which a link, shown as an icon of the vendor and an arrow to the available product-item and pointed at with a hand GUI, for purchasing the product-item that is displayed in the video, is integrated into the video, in accordance with an embodiment;

FIGS. 14B-G is a series of screenshots showing how the innovative platform enables the user to view the video and purchase the product shown in the video without ever leaving the video, in accordance with an embodiment;

FIG. 15 is a schematic diagram of the system architecture for automatic continuous user authentication on a smartphone, in accordance with an embodiment;

FIG. 16 is an accelerometer x-axis plot, depicting a graph of the data from the accelerometer's reading of a typical user's handling of their smartphone, in accordance with an embodiment; and

FIG. 17 is a schematic diagram of the innovative user authentication CNN model architecture, according to an embodiment.

### DETAILED DESCRIPTION

Techniques are provided by which the digital delivery of a viewer-requested video along with the best chosen advertisement for the viewer is improved. These techniques may be particularly suited for the short video industry. An innovative video analytics mechanism and user-behavioral analytics mechanism are provided, with which the best match of an exact product on the video for the particular viewer is advertised on the video, while the viewer is viewing the video. Further, techniques are provided that enable the viewer to purchase the product while still in the video, not having to leave the video or the site to complete the purchase.

As mentioned above, presently, companies provide platforms on which creators may upload their digital videos for viewers to consume. To support their efforts, such companies may allow digital advertisements from third-party vendors to be displayed along with the video.

These advertisements might be presented before or after the video is streamed. Worse, the video stream may be interrupted in the middle so that the advertisement is played. In other examples, the advertisement might be played on the screen space with the video, perhaps alongside the video or as a small window overlaying the video. In all of these configurations, the advertisement selected may not be correlated with one or more of the objects within the video being viewed. In addition, when a viewer desired an object in the video and would like to purchase that object, the viewer is required to perform many additional steps on the Internet, such as executing one or more searches for the item, going to one or more vendors' websites to study the attributes of the product, and opening the webpage to buy the desired item.

All of the present day steps required for a viewer to purchase the exact product as seen in the video takes many actions on the Internet, including opening many webpages. When millions of viewer across the globe are in the process of viewing videos and trying to purchase products as seen within the videos, a lot of processing cost is had, a lot of server chargers are made, and a lot of data is going back and forth, across the Internet. These events directly affect the performance of the all users of the video sites, the vendors, the creators, and the performance of the Internet in general. The Internet slows down. The website slows down. There is the problem of load management for Content Delivery Networks (CDN).

The innovation described herein solves the problem by improving the processing time for e-commerce technology, timewise and processing cost-wise. In addition, techniques described improve digital user-consumption technology and improve user-convenience. Now, instead of the viewer imposing many costs on the Internet channel, as described above, the viewer can check out and purchase a product within the video, itself.

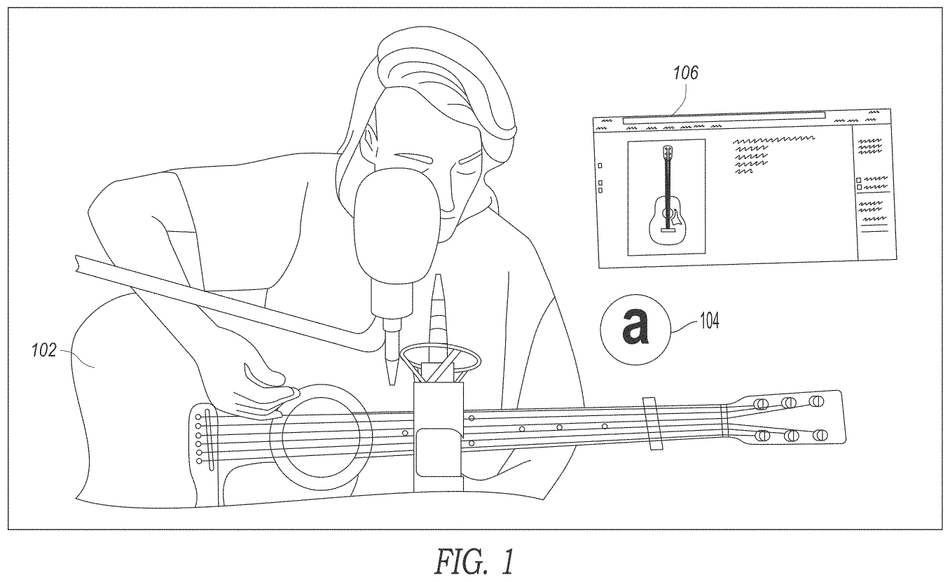

The innovation is a system, method, and/or platform (“system,” “process,” or “platform”) that recognizes the objects from a video, places automatically an augmented reality-based (AR) advertisement (ad), and enables the viewer to purchase the product in the advertisement from the video, while still viewing the video. As shown in the picture, e.g. video frame, in FIG. 1, the innovation detects all the objects in the video and automatically places the AR advertisement. For example, the innovation detects the guitar 102 and automatically places the vendor's brand indicator, e.g., logo 104, and the guitar's product information, such that the viewer can purchase the same guitar while viewing the video. The innovation involves the features of detection, segmentation of the viewers, and placing the AR advertisement.

The innovation parses the video into frames and detects the objects in the frames of the video. Then the system automatically detects each pixel in the frame and tags those pixels with one of the detected objects. For example, there is a lot of data about what is going on with the video file. In one second there may be seven tress, four birds; in this part of the frame, two seconds, there is this-this-this; three seconds, there is this-this-this, etc. In a one hour video, based on every single second, there is a whole database of the objects and in which coordinate the objects are within the file. Artificial intelligence techniques are used to explain what is going on in predetermined portions of the video, such as in each corner. The AI may indicate that in the left side there is a cup, on the right side there is a white plate, in the other corner there is a white cup, and this-is-this. AI is explaining what is happening in each frame and writing the information down in a file such as a JSON formatted file. This file may be looked back, at any time there is a request. That is, this process a one-time analytics, in which the AI completely explains everything. Also, the AI It explains what is the name of the brand that is present in the video, for example, by accessing a dictionary of products stored in the Ad library.

Thus, when the video is played to the viewer, the viewer may tap each object (which has been tagged in each pixel) and then see an appropriate, corresponding, or matching augmented reality-based advertisement. For example, in FIG. 1 the system automatically had detected the whole guitar so that when someone taps any part of the whole guitar, then AR-based advertisement about the guitar comes up.

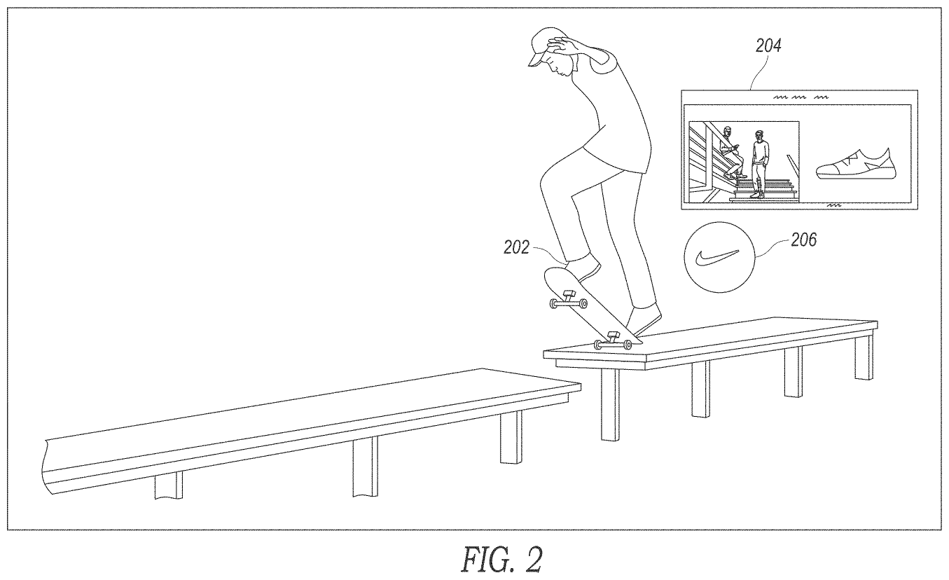

Another embodiment is illustrated in FIG. 2. In FIG. 2, the system had previously detected and tagged the shoes 202 and, upon user clicking or moving the mouse over the shoes, automatically displayed in real-time the AR advertisement 204 with the vendor's logo 206 to the viewer.

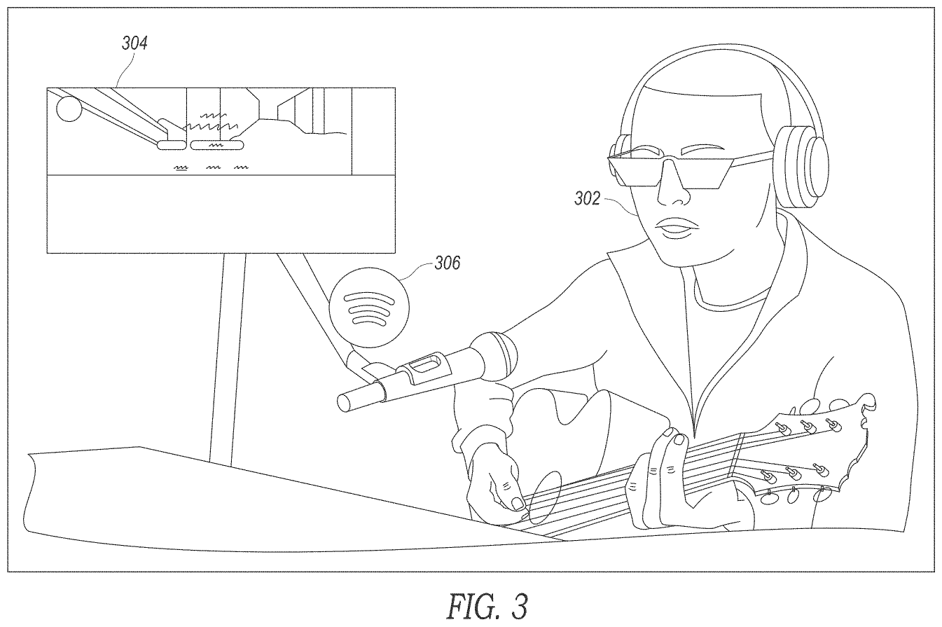

In one embodiment, as the viewer watches videos, the system continually monitors and analyzes the viewer's linking to sites and, based on that information, creates a list of objects that the system determines the viewer wants to see as advertisement. More specifically, the process proceeds as follows. In video 1: there are 10 objects; in video 2 there are 5 objects; in video 3 there are 2 objects; and in video 4 there is the 1 object with augmented reality-based advertisement. According to the process, in video 1 the system recognized the 10 objects and matches the viewer's demographics and interests with the objects, performs statistical analysis and, subsequently, places a video with 5 objects that falls within the viewer's demographics and interests, based on the first video and his previous history. The process repeats until the system detects the one object that the system determined the viewer is looking to buy and an appropriate advertisement is placed. That is, the system repeats the process until the system finds the object that has the highest probability of the viewer liking it and an advertisement is placed or overlaid. For example, in FIG. 3, the system had recognized the identity of the artist 302 and placed the augmented reality-based animation 304 and a logo 306 about his music.

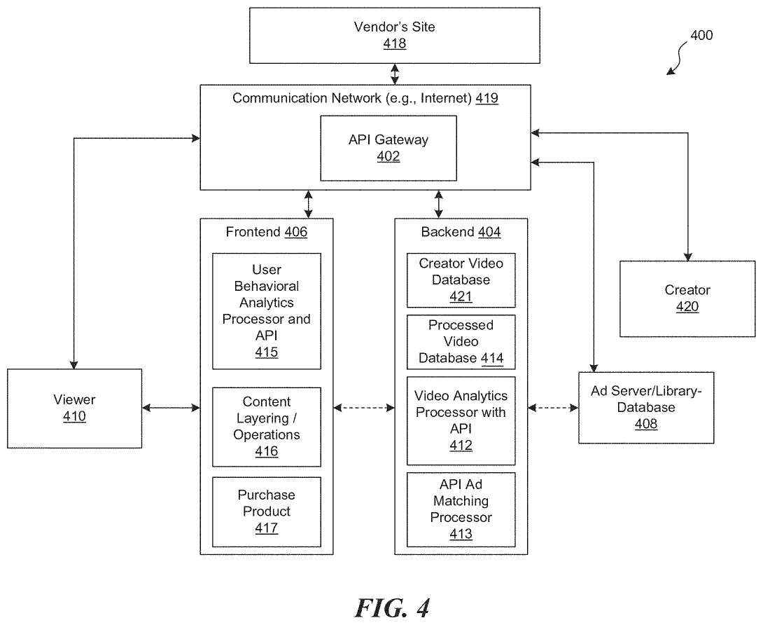

An embodiment may be understood with reference to FIG. 4, a schematic diagram of a high-level architecture of the network environment 400. A creator uploads a video to a site so that the video may be watched later by others. For example, creator 420 uploads their video to the database 421 of an enterprise or a social network site, such as for example, Tiktok, YouTube, or Facebook.

Once the video is uploaded, the video is analyzed. For example, in response to the video file being uploaded to creator video database 421, the video analytics component 412 processes the video. In an embodiment, the video analytics component 412 may include a processor and one or more application programming interfaces (API) for processing data in accordance with one or more proscribed algorithms. In an embodiment, video analytics component 412 analyzes the video in four parts:
analyzes basic or standard video information;
analyzes to recognize and identify objects within the video;
determines or establishes the class of the object, according to a predetermined classification system of definitions; and
identifies the exact product that is each object, e.g. by referencing a preloaded Ad server or Ad library.

After completing the analysis process described above, the video analytics component 412 logs the video file to a logfile or register file. Also, the video analytics component 412 records the data resulting from the analysis to a JSON formatted file and stores the JSON file in the processed video database 414 for future retrieval.

An embodiment may be understood with reference to Table A, pseudocode of an exemplary video analytics algorithm, consistent with embodiments herein.

TABLE A
Analytics:
from app.database.models import UploadedVideo,VideoAnalyticsFile,GeneratedVideo
from datetime import datetime
from app.utils.dataUtilsCode import getDetectedObjectsforDatabase,uniqueClassSetAndDict,uniqueDictonairies,

|arrangeNnumberOfDictionary,returnList,writeListAsAJsonFile

from app.darkflowMerge.openCVTFNet import extractFrameInfosFromVideo,extractIndicesFromTuple,frameToVid
from flask_login import current_user, login_required

In accordance with the exemplary video analytics algorithm, the process imports the uploaded video, a video analytics file, and the generated video. These files may be filled with information or they may not be filled with information. These files and their data are stored in the database 414. It should be appreciated that the videos are stored in database 414. The process extracts the exact data and time of the import, referred to as import datetime. Then, the process imports the detected objects from the database, the unique class set and dictionary of the objects. For example, the detected objects may be pants, a shirt, and shoes, in the video. Then, the unique class set is imported. For example, the shirt is for a woman, the pants are for a young man, and the shoes are for a young man. Then, the unique dictionary is imported. For example, the exact product for each object. The shoes are Nike, Product No. 12345. The exact product was determined by performing a match operation in the Ad server or library (e.g., Ad Server 408), in which vendors has previously provided their product information. Then, the informational data is written to a record or file (e.g., a JSON file) for future retrieval. Also, the process finds information from each frame of the video, extract frame to frame information from video. The process also extracts the indices from the tuple. For purposes of the discussion herein, tuple means when the video has been divided into thousands of different frames, every frame is assigned a number (1, 2, etc.). At the end of the process, the system obtains the basic user information and login number.

Thus, for example, if creator 420 loads a video in which a person is wearing a woman's white Nike cap, then the process is configured to know on which frames the cap appears and the exact brand and product number of that cap.

In an embodiment, the vendor 418 transmits product description data (e.g., product number, color, size, etc.) for potential viewer purchase in Ad server-database 408. This process may be ongoing. When a vendor is ready to sell its products, the vendor may provide the required information to Ad server 408. In an embodiment, the vendor is enabled to provide the advertisement data by transmitting the data from vendor's site 418 to Ad server-database 408 via communication network 419. In another embodiment, vendor's site 418 is communicably connected to Ad server 408 directly.

In accordance with embodiments herein, the view requests to view a video. For example, viewer 410 makes a request to the frontend 408 component to view a video. For instance, the viewer may want to watch a specific video on Tiktok.

The frontend 406 receives the request and performs the following operations:
obtains user-behavior analytics (that is continuously being performed) about the user from the user-behavior analytics component 415; and
forwards the video request information along with the user-behavior analytics data to the backend 404/API Ad Matching Component 413.

An embodiment may be understood with reference to Table B, pseudocode of an exemplary user-behavior analytics algorithm, consistent with embodiments herein.

TABLE B
Rating-ranking-page optimization-content aware recommendations: What
is best for going on the video?
Recommendations Using a User Vector: What is best for based on user
User vecor?
Content-based and collaborative behaviours of users and recommendation
systems.: What is best for based on other user data?
Collaborative Denoising Auto-Encodersfor Top-N Recommender Systems:
What is best for based on data that not needed?
This is what maths process used

Regression models(logistic,linear,elastic nets):
Tree-based methods(gradient-boosted, Random Forests)
Matrix Factorizations
Factorizations machines
Restricted Boltzmann machines
Markov chains and other graphical models
Clustering (from k means to HDP)
Deep learning, neural nets
Linear discriminant analysis
Association Rules

Features:
titles watched or abandoned in a past
members with similar tests/user data
titles with similar attributes
propensity to rewatch
preference for what the user is watching
ratings
time of day day of viewing session
voracity of consumptions
use of list searches

In response to the request, video analytics processor 412 sends video information, such as objects recognized in the video, to the API Ad Matching 413. API Ad Matching 413 takes these two inputs, the input from the user-behavioral analytics component and the input from the video analytics component, compares the data from each input together, and determines matching objects and assigns their respective scores. The backend may indicate that there are 10 objects (shirt, pants, hat, etc.) and the frontend may indicate that there are two objects (shirt and shoes) that that person is interested in. For example, API Ad Matching 413 may determine that the shirt gets a score of 8 points (for example, because there is a match of a shirt object from the video analytics input and a shirt from the user-behavioral analytics input) and the shoes gets a score of 1 point (e.g., the API Ad Matching component 413 may be instructed to provide a back-up or default-type object, or the shoes might get a score of 1 dependent on other factors such as past input objects). Alternatively, the API Ad Matching component 413 may determine that just the Shirt Ad and not that Pant Ad are requested (e.g., the API Ad Matching component 413 may be instructed to submit only one object, e.g., the object with the highest score, and attributes to the Ad Server 408). Then, API Ad Matching 413 sends the score of best object with attributes to the Ad Server 408 for obtaining the product informational data (that was previously provided by the vendor and stored therein). For instance, API Ad Matching 413 sends the shirt attributes and the corresponding score of 8 points to the Ad Server 408 for obtaining the exact product advertisement-related informational data for that shirt (e.g., Nike shirt, size=men's small, color=green, product #45678.

In an embodiment, Ad Server 408 receives the score and attributes and finds/determines the corresponding (e.g., best) ad for that video and sends the Ad file corresponding to the product back to the backend 404/API Ad Matching 412 component. In an embodiment, the Ad Server 408 had been prepopulated, by the vendors, with product-related data by appropriate storage capabilities, such as dictionaries, look-up tables, database and related support, and the like. In an embodiment, whenever the vendor wants to offer its product, the vendor loads the product-related data to the Ad Server component 408. This process of the vendor uploading products for selling or promoting may occur on a continual basis by the same vendor or other vendors.

The API Ad Matching component 412 receives the best Ad file and performs a double-checking operation for accuracy. For instance, it checks whether the attributes of the object in the received Ad file matches those of the products (e.g., is the product received a green, women's shirt?).

In an embodiment, the backend component 404 delivers the requested video file from processed video database with the best Ad file from the API Ad Matching 412 to the frontend component 406.

In an embodiment, the content layering component 416 receives the Ad file and the video and layers the content of the Ad over the requested video to create a video plus Ad package. It should be appreciated that such content layering process may occur in real-time, while the viewer is already watching the video. Or, the content layering process may occur before the viewer begins to watch the video, when the video is presented to the viewer. For instance, the ad content may have been layered on specific frames and are not presented until the viewer's streaming process arrives at those frames.

Also, in an embodiment, the advertisement content may be layered, superimposed on, or injected into the video according to one or more of the following processes:
content layering;
content injection;
content repurposing;
content re-forging;
GAN-enabled with content editing; and
content editing.

It should be appreciated that the term, content layering, may be used herein to mean any of the specific processes outlined above and may not be meant to be limiting.

Further, it should be appreciated that the term, content-layer, used herein may mean in-video product placement. Examples of such in-video product placement are illustrated in FIGS. 1 (104 and 106); FIG. 2 (204, 206), and FIGS. 3 (304 and 306).

In an embodiment, the frontend 406 delivers the video plus Ad package to the viewer 410 for viewing.

At some point, the viewer decides to purchase the product within the video. In an embodiment, the viewer 410 interacts with video to purchase presented product, by:
clicking or otherwise selecting that Ad to buy the product within the video by selecting overlaid product-detail window and entering required viewer informational data (e.g., address, payment information (e.g., credit card number), and attributes of the product). For example, the product placement GUI (e.g., 106) may be editable, in which the viewer may insert the required purchase information. In another implementation, the product placement GUI (e.g., 204) may have an embedded link such that when the viewer clicks on the GUI (e.g., 204), another GUI (e.g., dialog window) may pop-up into which the viewer may insert the purchase information discussed above.

In response to receiving the viewer's input information, the purchase product 417 component may perform the following operations:
One) Redirect the viewer to the link that was provided by the vendor in the originally provided information to the Ad server 408. The link may take the viewer to an Ad for the product, from which the viewer may continue to purchase the product. Alternatively, the link may take the view to the vendor's site 418 from which the viewer may continue to purchase the product.
Two) Allow the viewer to purchase the product within the video, itself. The frontend 406/purchase product 417 component takes the three pieces of viewer informational data described above and sends such information to the vendor's site 418 to complete the purchase.

In an embodiment, communication network 419 is illustrated as a generic communication system. In one embodiment, the communication network 419 comprises the Internet. In one embodiment, the communication network 419 comprises the API Gateway 402, a logical hub for the APIs of the frontend 406, the backend 404, and the Ad Server 408 to connect and communicate. In an embodiment, the API Gateway 402 monitors and organizes API requests from the interested parties. As well, the API Gateway 402 may perform other auxiliary operations, such as authentication, rate limiting, and so on. Accordingly, interfaces may be a modem or other type of Internet communication device. Alternatively, the communication network 419 may be a telephony system, a radio frequency (RF) wireless system, a microwave communication system, a fiber optics system, an intranet system, a local access network (LAN) system, an Ethernet system, a cable system, a radio frequency system, a cellular system, an infrared system, a satellite system, or a hybrid system comprised of multiple types of communication media. In such embodiments, interfaces are configured to establish a communication link or the like with the communication network 419 on an as-needed basis, and are configured to communicate over the particular type of communication network 419 to which it is coupled.

In an embodiment, the frontend 406 is a viewer or end-user facing component such as those provided by enterprises. Examples of enterprises hosting the frontend 406 components may include social networking sites (e.g., Facebook, Instagram, etc.) or dedicated short video viewing sites (e.g., Tiktok). In an embodiment, the viewer device, which may be represented as viewer 410, may be directly connected with the frontend component 406 as an in-app connection.

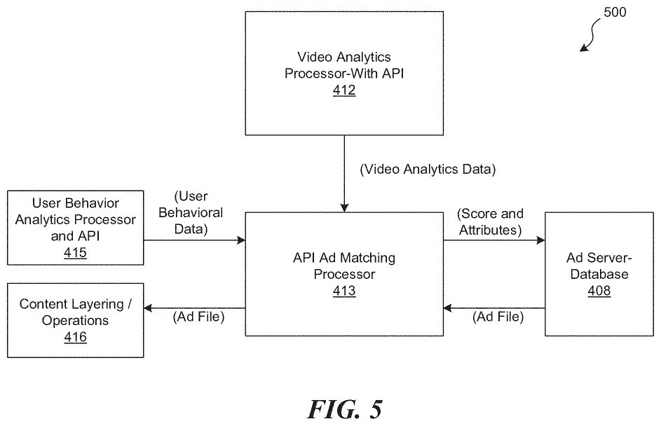

An embodiment of the API Ad Matching processing can be understood with reference to FIG. 5, a schematic diagram of the API Ad matching process and best Ad file delivery process 500. The video analytics processor with API (e.g., 412 of FIG. 4) sends video analytics data to the API Ad Matching processor (e.g., 413 of FIG. 4). Similarly, the user-behavior analytics processor and API component (e.g., 415 of FIG. 4) sends user-behavioral data of the viewer also to API Ad Matching processor (e.g., 413 of FIG. 4). The API Ad Matching processor (e.g., 413 of FIG. 4) compares the data from the two inputs to generate objects deemed to be common to both inputs and their respective scores, as described above. Then, the API Ad Matching processor (e.g., 413 of FIG. 4) sends the score(s) and corresponding object attributes to the Ad database or library (e.g., 408 of FIG. 4) to obtain a product match for each object. In another embodiment, the API Ad Matching processor (e.g., 413 of FIG. 4) may send only the highest score and corresponding attributes to the Ad database or library (e.g., 408 of FIG. 4) to obtain a matching product. In an embodiment, when there is not a match within a predetermined tolerance measurement, no product may be returned. Similarly, a product that is the best fit match may be returned.

In an embodiment, the Ad database or library (e.g., 408 of FIG. 4) sends the Ad file to the API Ad Matching processor (e.g., 413 of FIG. 4). Such processor may verify that the item in the Ad file is correct, within a predetermined tolerance. Subsequently, the Ad file is sent to the frontend component 406. In an embodiment, the Ad file is sent back to the user-behavior analytics processor and API component (e.g., 415 of FIG. 4), which then sends it to the appropriate processing component within the frontend 406. Alternatively, the Ad file is sent back to the content layering/operations component (e.g., 416 of FIG. 4) for being layered or otherwise ingested into the video.

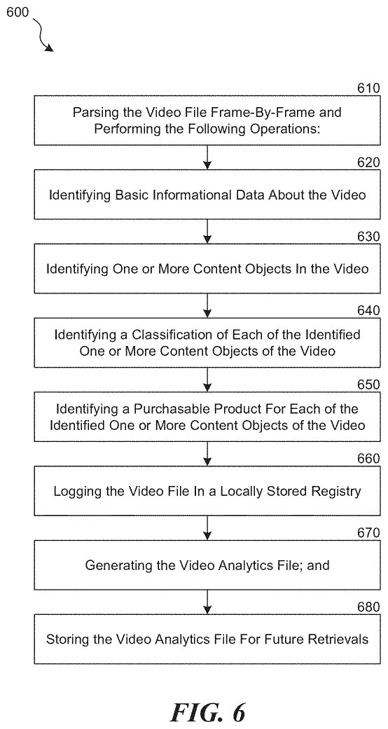

An embodiment of a video analytics process can be understood with reference to FIG. 6, a flow diagram for analyzing and storing video data, including identifying objects within the video and identifying products within the video. It should be appreciated that this process may be performed by the video analytics component executed by a processor 412. At step 610, the process includes parsing the video file frame-by-frame and performing the following operations. At step 620, the process identifies basic informational data about the video, such as the title and length. At step 630, the process identifies one or more content objects in the video, such as for example, shirts, guitar, shoes, and skateboard. At step 640, the process identifies a classification of each of the identified one or more content objects of the video. For example, the shirt may be classified as a men's shirt. The skateboard may be classified as a young person's toy. At step 650, the process identifies a purchasable product for each of the identified one or more content objects of the video. For example, video analytics component 412 may access or obtain from Ad server-database 408 exact product data that corresponds to the objects in the video. For example, video analytics component 412 may obtain from Ad server-database 408 that the type of shirt is a men's Nike sportswear shirt in the color green, with product number 23456. At step 660, the process logs the video file in a locally stored registry so that the system knows that it is there and can access the video file information at a subsequent time. For example, the log entry may include the title of the video, the identification number of the video, and other attributes such as size of video and when it was obtained. At step 670, the process generates the video analytics file in which the information necessary for a viewer to request the video and have the best Ad displayed thereon is stored within the video analytics file. In an embodiment, such file is a JSON formatter file. At step 680, the process stores the video analytics file for future retrievals. That is, each time a viewer requests to view the video, the full analytics of the video is present in the file. The Ad that is displayed to the viewer is dependent on the input data from the user-behavioral analytics component (e.g., user-behavioral analytics processor and API 415). In one embodiment, the video and the Ad information are delivered to the viewer and it is the input from the user-behavioral analytics component that determines which Ad is presented. Alternatively, the video and the best Ad is delivered to the viewer.

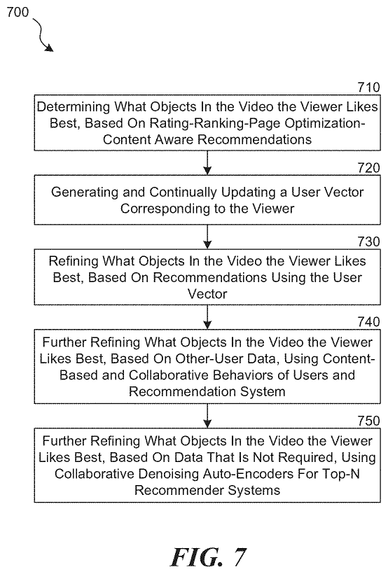

An embodiment of a user-behavioral analytics process with API can be understood with reference to FIG. 7, a flow diagram for analyzing user-behavioral data 700, including identifying objects viewed on videos. An exemplary user-behavioral analytics process with API may be 415 of FIG. 4. At step 710, the process determines what objects in the video the viewer likes best, based on rating-ranking-page optimization-content aware recommendations. For example, the process may determine that the viewer has a young adult son who has a birthday approaching and that the viewer has been determined to like sports clothing of young men. At step 720, the process generates and continually updates a user vector corresponding to the viewer. For example, the user vector may contain information identifying the viewer as being a late middle-aged woman of short stature, having a post-graduate degree, and having appears in a specific range of household income. At step 730, the process refines what objects in the video the viewer likes best, based on recommendations using the user vector. For example, the video may contain an object with a designer shirt for men. The process may determine that the viewer may like this item. At step 740, the process further refines objects in the video the viewer likes best, based on other-user data, using content-based and collaborative behaviors of users and recommendation systems. For example, the process may discover that the viewer has friends on social networking applications who like traveling to resorts. Thus, the process may determine that among the already selected objects, the viewer likes the objects which can be used in hot weather and for a vacation at a resort-type location. For instance, the process may identify a young man's trending Nike cap as being of high interest and a tasteful pair of sunglasses to the viewer. At step 750, the process further refines the objects in the video the viewer likes best, based on data that is not required, using collaborative denoising auto-encoders for top-n recommender systems. For example, the process may eliminate as irrelevant data that indicated that the viewer was viewing links and videos on baby items for one day only, as opposed to numerous days looking at vacation-related videos and links.

In an embodiment, the platform includes one API set in the backend server 404 and one API set in the frontend server 406. Such APIs connect three things. One is the backend database, where the videos are stored (e.g., database 414), the frontend viewing experience (frontend 406 accessible to viewer 410), where the end-user is going to view the video, and the ad servers (e.g., ad server-database 408).

### An Exemplary Process

An exemplary process is described as follows, in accordance with embodiments herein. In the backend (e.g., 404), the backend API (e.g., video analytics processor with API 412) has already analyzed every single video file that is stored in there (e.g., in database 414). While it analyzes the video, the API does a few things, including looking at every single frame, analyzing what is going on there, and keeping a log file of the information. Meanwhile, the frontend (e.g., user-behavioral analytics processor and API 415) is constantly segmenting the viewer. Such segmentation is done based on how the viewer is viewing the content, what is in the content, and how the viewer reacted to the specific content. The frontend 406 is constantly reacting to and/or trying to figure out what the viewer or end-user is interested in.

Then, on the viewer side, suppose the viewer is watching a video of someone dancing. In that video, in the backend, the viewer has requested a video file. The backend server had sent the video file to the viewer. In the backend, there is one API (the backend API) that knew that now the viewer is ready to be served an ad. Thus, the backend API, is prepared to communicate with the frontend indicating, show this small file to this user. However, at the same time while on the way, the backend picks up a small ad from the Ad Library and brings it with the video for delivery to the frontend.

Thus, referring to FIG. 1, as with the viewer watching the person playing guitar with an Amazon popup and the logo, there is the backend server where such video file is stored, and there is an API that has all the analytics, as discussed above. In an embodiment, in the frontend, while the viewer is watching the video, the backend API knows that the viewer is ready to see an Ad. The frontend requests, e.g., by sending objects to the backend, that the viewer see even more interesting guitar-related ads. The backend (e.g., the API Ad Matching Processor 413) accesses the Ad Server 408 and gets a Guitar Ad from the Ad Library 408. The frontend API picks up that Guitar Ad and layers that Ad in front of the viewer in real-time or as a different video is being delivered.

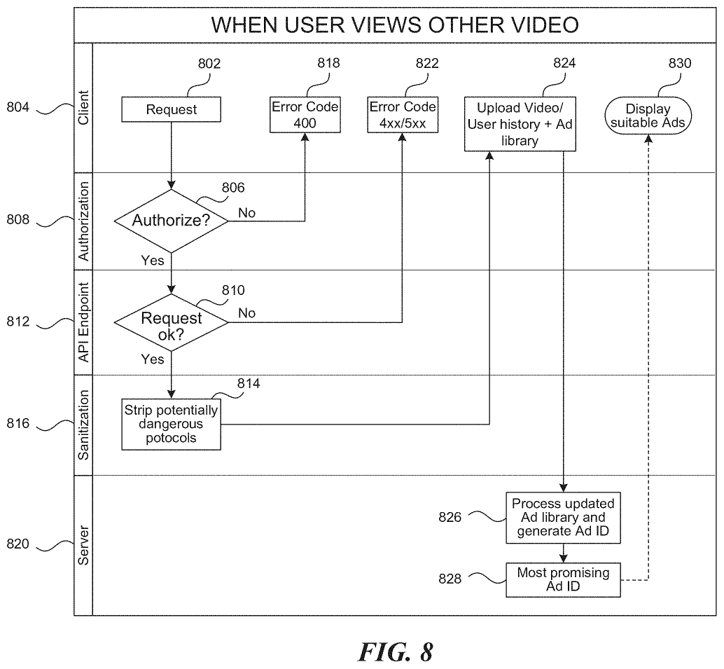

An embodiment can be understood with reference to FIG. 8, a network environment for when a viewer views the video (e.g., the creator's video). The server (e.g., frontend 406) receives a request 802 for a video from the client device 804. In response to the receipt, an authorization processor 808 determines whether the client is authorized to obtain or view the video. For example, the server checks whether it a private video or a public video. If it is a public video, then the server checks whether this client has access ability. If so, the process continues along the “yes” path. If not, an error code 818 is returned to or displayed for the client 804. If yes, control goes to an API Endpoint processor 812. Such API Endpoint processor 812 checks whether the request, itself, is acceptable 810. If no, then the appropriate error handling 822 is performed. If yes, the control goes to a sanitization processor 816. Such processor strips the request of potentially dangerous protocols at step 814. After doing so, at step 824, the video is uploaded at the client, along with user history being updated and the appropriate Ads from the Ad library being sent with the video. At step 826, the process is updated and goes to the backend server 820, to the Ad library to generate an Ad ID. At step 828, the server 820 updates the Ad library or provides user history and generates the most promising Ad(s) ID(s). The most promising Ad(s) ID(s) are used to obtain the most promising Ads. Such most promising Ads are transmitted by the server 820 to the client 804 for display 830. For example, a video has a lot of personal information in terms of the labels. The labels are stripped and only the video files are sent to the client. Thus, for example, each time a creator uploads a video in a company's (e.g., TikTok) video site, the site records details about the video. For instance, a video with John, age such-and-such, and other personal details are whom sent this video. However, when someone is viewing, this is very private information. The viewer only sees the video content, e.g., that it is a dance video The sensitive information is stripped.

In an embodiment, step 802 (request) may be executed by the viewer 410; step 824 (upload video) may be executed by creator 420; step 826 (process updated Ad library and generate Ad ID) may be executed by Ad server-database 408; and step 830 (display suitable Ads) may be executed by frontend server 406.

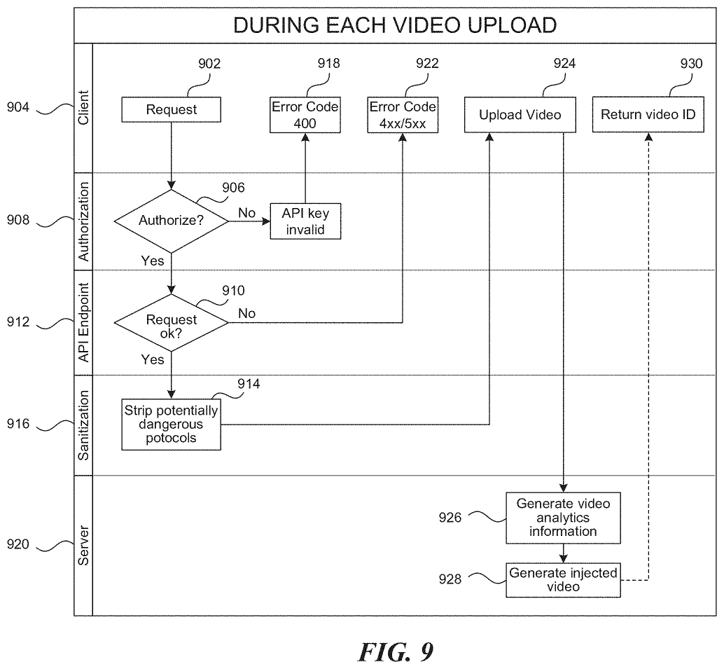

An embodiment can be understood with reference to FIG. 9, a network environment for during each video upload. Similarly, as in FIG. 8, the server (e.g., frontend 406) receives a request 902 for a video from the client device 904. In response to the receipt, an authorization processor 908 determines whether the client is authorized to obtain or view the video. For example, the server checks whether it a private video or a public video. If it is a public video, then the server checks whether this client has access ability. If so, the process continues along the “yes” path. If not, the authorization process 908 may determine that the API key is invalid 906. In this case, an error code 918 is returned to or displayed for the client 904. If yes, control goes to an API Endpoint processor 912. Such API Endpoint processor 912 checks whether the request, itself, is acceptable 910. If no, then the appropriate error handling 922 is performed. If yes, the control goes to a sanitization processor 916. Such processor strips the request of potentially dangerous protocols at step 914. After doing so, at step 924, the video is uploaded at the client. At step 926, the server 920 generates video analytics information about the video. At step 928, using the video analytics information, the server 920 generates the injected video. At step 930, the server 920 returns the video ID to the client 904.

In an embodiment, step 902 (request) may be executed by the viewer 410; step 924 (upload video) may be executed by creator 420; and step 926 may be executed by the video analytics component 412.

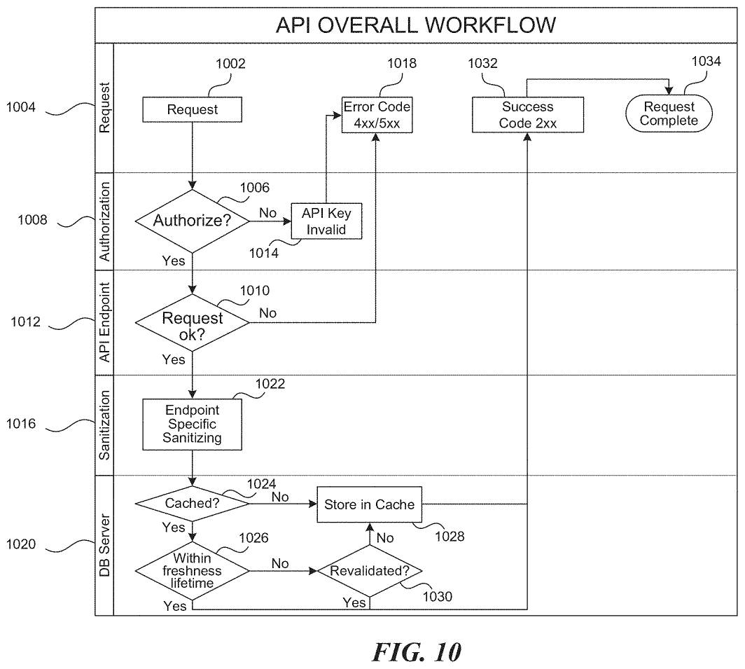

An embodiment can be understood with reference to FIG. 10, a network environment for API overall workflow. A request processor 1104 receives the request 1002. The authorization processor 1008 determines whether the request was authorized 1106. If not, it is found that the API is not valid 1014. An error handling code is activated 1018. If yes, the API Endpoint processor 1012 checks whether the request is acceptable 1010. If not, the error handling code is activated 1018. If yes, the sanitization processor 1016 performs endpoint specific sanitizing 1022, consistent with embodiments described above. Then the database server 1020 determines whether the request has been cached 1014. If not, the request is stored in cache 1028. If yes, the database server 1020 determines whether the date and time of the request is within a freshness lifetime threshold 1026. If not, the database server 1020 determines whether the request has been revalidated 1030. If not, the request is stored in cache 1028. If yes, the request is a success and a success code 1032 is associated with the request 1004. If the database server 1020 determines that, yes, the date and time of the request is within a freshness lifetime threshold 1026, then the request is a success and a success code 1032 is associated with the request 1004. At step 1034, the request is complete 1034.

In an embodiment, step 1002 (request) may be executed by the viewer 410; steps 1024 (cached?), 1026 (within freshness lifetime), 1028 (store in cache), and 1030 (revalidated?) may be executed by backend server 404; and step 1034 (request complete) may be executed by the frontend server 406.

In another exemplary aspect, a method for providing in-video product placement and in-video purchasing capability using augmented reality is disclosed. The method includes receiving a request for a video, the request initiated by a viewer; in response to receiving the request, retrieving, from a video database, a video analytics data file corresponding to the requested video, the video analytics data file comprising analytical data about the video; receiving a user-behavioral data file, the user-behavioral data file comprising information about the viewer's current viewing habits and viewing preferences; transmitting the video analytics data file and the user-behavioral data file to an ad matching component executed by a processor; comparing, by the ad matching component, the video analytics data file and the user-behavioral data file and determining one or more similar objects from each of the files that are considered to be matching; generating, by the ad matching component, a corresponding one or more scores for the one or more matching objects; transmitting, to an ad server component executed by a processor, a highest score corresponding to one of the matching objects and attributes of the one of the matching objects; receiving, from the ad server component, an ad file corresponding to the highest score and the attributes and the ad file comprising data of a product, wherein the product is associated with the highest score and the attributes; retrieving from the video database, the requested video file; delivering, to a frontend component executed by a processor, the video file corresponding to the requested video and the ad file, the delivery intended for a content-layering component for presentation to the viewer; and superimposing on or injecting into, by the content-layering component, the contents of the ad file to the video before displaying the video, wherein the superimposed or injected contents of the ad file comprise the product data and wherein the displayable product data are configured to be interactive for the viewer to purchase the product.

Additionally, the video analytics file was generated by a video analytics component executed by a processor, the video analytics component parsing the video file frame-by-frame and performing the operations of: identifying basic informational data about the video; identifying one or more content objects in the video; identifying a classification of each of the identified one or more content objects of the video; identifying a purchasable product for each of the identified one or more content objects of the video; logging the video file in a locally stored registry; generating the video analytics file; and storing the video analytics file for future retrievals.

Additionally, the video analytics file is a JSON formatted file.

Additionally, the video file was uploaded to the video database by the creator.

Additionally, the method further comprises: receiving, by the ad server component on an ongoing basis from one or more vendors, product description data corresponding to products that are offered by the one or more vendors; and storing, by the ad server component in local dictionary, the product description data about the product for future retrieval; wherein the product description data is sufficient for the vendor to identify the product for a purchase request.

Additionally, the product description data comprises: price of product; product identifier; and product attributes.

Additionally, the method comprises receiving, by a purchase product component executed by a processor and from an overlaid product-detail window from the video file as the video file is being streamed by the viewer, a request to purchase a product corresponding to the product in the overlaid product-detail window, wherein the request comprises required viewer informational data for purchasing the product.

Additionally, the required viewer informational data comprises three pieces of information: the delivery address for where the product is to be delivered; credit card information, debit card information, or other currency information for actuating the purchase of the product; and informational data about the product for identifying the product.

Additionally, the method comprises transmitting, by the purchase product component, the three pieces of information to the vendor, causing the completion of the purchase.

Additionally, the user-behavioral data file was generated by a user-behavioral component executed by a processor, the user-behavioral component performing operations as the viewer views each video of one or more videos, the operations comprising: determining what objects in the video the viewer likes best, based on rating-ranking-page optimization-content aware recommendations; generating and continually updating a user vector corresponding to the viewer; refining what objects in the video the viewer likes best, based on recommendations using the user vector; further refining what objects in the video the viewer likes best, based on other-user data, using content-based and collaborative behaviors of users and recommendation systems; and further refining what objects in the video the viewer likes best, based on data that is not required, using collaborative denoising auto-encoders for Top-N recommender systems.

Additionally, the following mathematical processes are employed: regression models, comprising: logistic, linear, and elastic nets; tree-based methods, comprising: gradient-boosted and random forests; matrix factorizations; factorizations machines; restricted Boltzmann machines; Markov chains and other graphical models; clustering, comprising: from k means to HDP; deep learning and neural nets; linear discriminant analysis; and association rules.

Additionally, the method further comprises generating, monitoring, and updating the following parameters on a continual basis: titles watched or abandoned in a recent past by the viewer; members with similar tests and/or user data; titles with similar attributes; propensity of the viewer to re-watch a video; preference for what the viewer is watching; ratings of the videos being watched by the viewer; time of day of viewing session by the viewer; voracity of video consumptions by the viewer; and use of list searches by the view.

### An Example Machine Overview

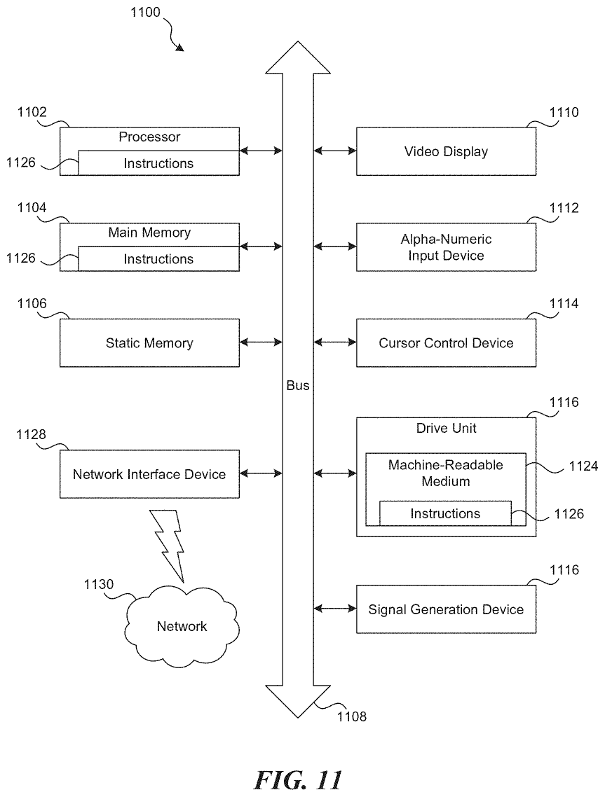

FIG. 11 is a block schematic diagram of a system in the exemplary form of a computer system 1100 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1100 includes a processor 1102, a main memory 1104 and a static memory 1106, which communicate with each other via a bus 1108. The computer system 1100 may further include a display unit 1110, for example, a liquid crystal display (LCD) or a cathode ray tube (CRT). The computer system 1100 also includes an alphanumeric input device 1112, for example, a keyboard; a cursor control device 1114, for example, a mouse; a disk drive unit 1116, a signal generation device 1118, for example, a speaker, and a network interface device 1128.

The disk drive unit 1116 includes a machine-readable medium 1124 on which is stored a set of executable instructions, i.e. software, 1126 embodying any one, or all, of the methodologies described herein below. The software 1126 is also shown to reside, completely or at least partially, within the main memory 1104 and/or within the processor 1102. The software 1126 may further be transmitted or received over a network 1130 by means of a network interface device 1128.

In contrast to the system 1100 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations, e.g. requiring cables and complex software configurations, e.g. requiring a consultant to install. For example, embodiments may provide one or more cloud computing solutions that enable users, e.g. users on the go, to purchase a product within the video on such internet-enabled or other network-enabled devices, servers, or clients. It further should be appreciated that one or more cloud computing embodiments include purchasing within the video using mobile devices, tablets, and the like, as such devices are becoming standard consumer devices.

### Exemplary Embodiments for Automating Video Ads

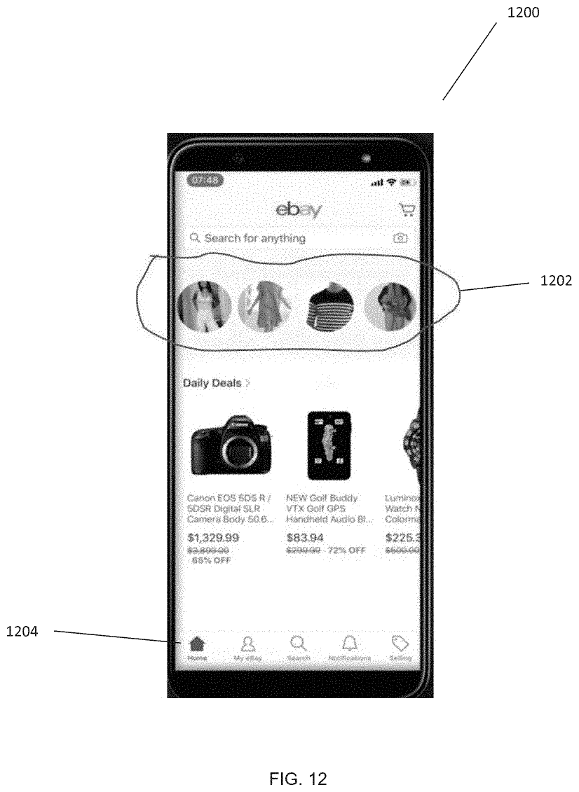

In an embodiment, the innovative platform is configured to open up a new branch to its existing automated video ads. In an embodiment, APIs are provided that transform any website in the world with a capability to have stories or video summaries of the user's homepage. An example is illustrated in FIG. 12, a screenshot 1200 of an e-commerce website on a smartphone, the screenshot showing a list of four video options 1202, shown as circled, that are selectable by the user to activate the corresponding video. In accordance with embodiments herein, this home page, as depicted by the highlighted Home icon 1204, is dynamic due to the innovation's APIs that create and make accessible such user-targeted video summaries or stories, as described in detail below. The platform embeds the user-targeted video summaries or stories into the home page of the particular vendor or provider website.

Here, again, it should be appreciated that the innovation may be referred to as a system, method, mobile application (“app”), and/or platform and refers to any of such interchangeably herein (e.g., “system,” “process,” “platform,” or innovation).

In an embodiment, the platform summarizes the videos that are available of the different products and creates a personalized feed for every single user. The platform's APIs, described below, are configured to work with any mobile application (sometime referred to herein as “app”) or website to create this functionality. An example of such app or website is the ebay website as shown in FIG. 12. It should be appreciated that other websites are contemplated, such as but not limited to, Macy's, Target, short form video media, live video, game streaming, over the top video platforms, telecommunications, social media, multichannel video programming distribution, and streaming companies. The platform is configured to bring video technology into any commerce website or any app with a personalized feed of products, video, or any service that the specific website or app is offering. This innovation changes the plain homepage of apps to a vibrant service which excites its users with a feed designed for them. The platform processes its behavioral pairing and product-user data matching. In an embodiment, the platform uses the user behavioral analytics processor and API component 415 of FIG. 4 and uses the video analytics processor with API component 412 of FIG. 4. The platform is configured to bring a multitude, e.g., 10-20, of products-in-video or services-in-video. In an embodiment, services that had been selected, by the platform, for that individual user with the innovation's algorithm, as shown in the API Ad Matching Processor component 413 of FIG. 4. Examples of services include: authenticate user, understand user behavior, target them with ads, and conduct e-commerce.

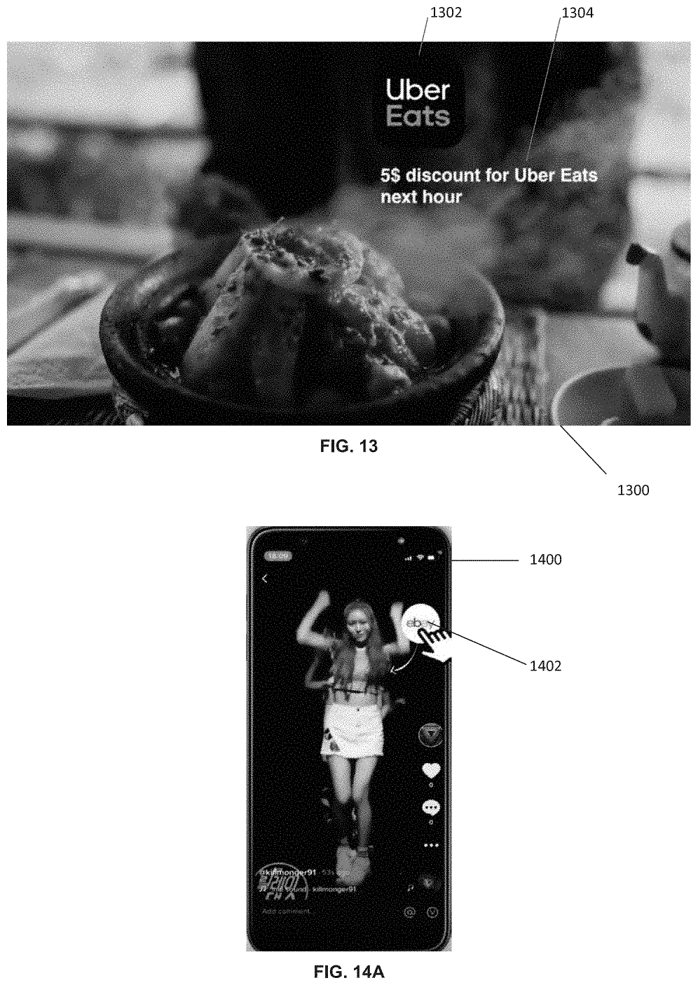

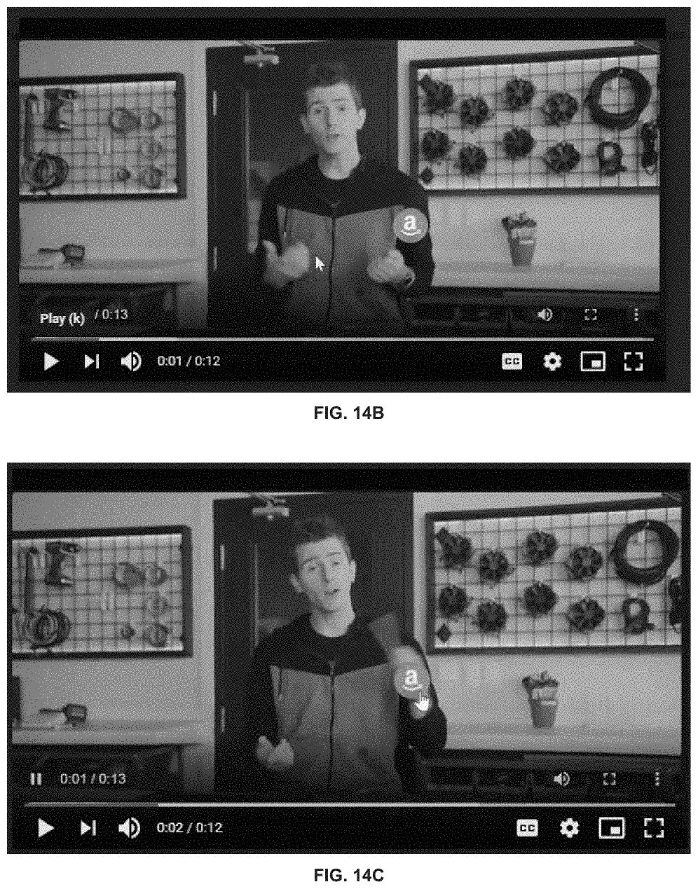

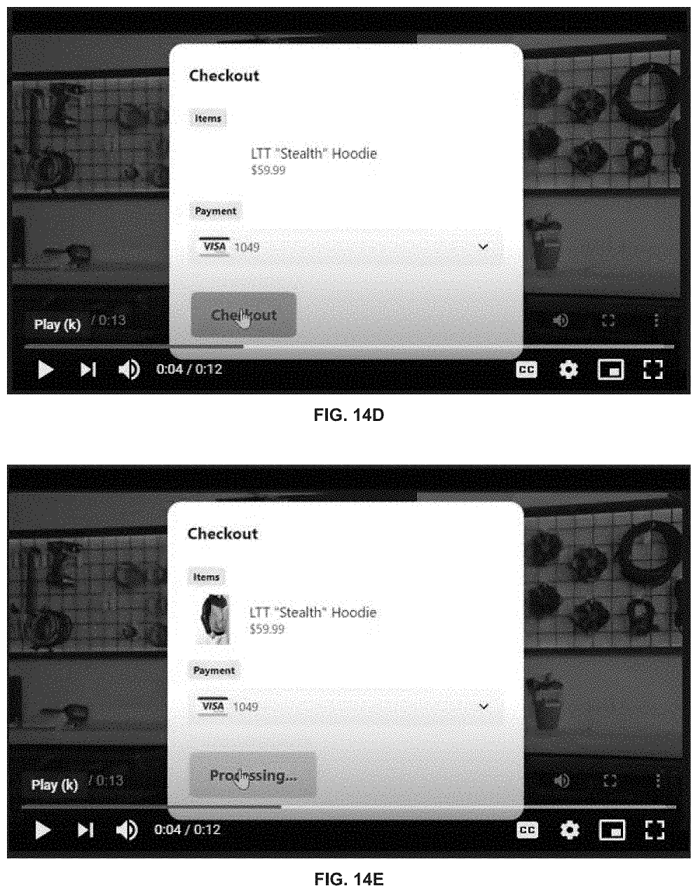

In an embodiment, the platform is configured to extend the service or functionality described above to real time personalized offers. With this innovation, a service company and/or app with Internet presence can transform traditional email-based offers to a personalized feed, that the platform's API created by matching the behavior of the user and content, plus ultra-targeted video offers such as illustrated in FIG. 13 and FIG. 14A. FIG. 13 is a screenshot 1300 of a cooked dish with an advertiser's company logo 1302 and link 1304 to a discount super-imposed over the original display of the cooked dish. In FIG. 14A, a screenshot 1400 of a short video in which a link 1402, shown as an icon of the vendor and an arrow to the available product-item and pointed to with a hand GUI, for purchasing the product-item that is displayed in the video, is integrated into the video.

It should be appreciated that the embodiments described above and illustrated in FIGS. 13-14 are referred to as the platform's In-App Optimization. That is, the platform optimizes the accessibility to the online purchasing of a product by presenting or integrating, on the webpage or app, the link to specific page where the user can purchase the product.

In an embodiment, the platform is configured to provide through the APIs an out-of-appl personalization. The platform creates a personalized feed of products or ads for the user that is referred to as an Off-App optimization of the APIs. The innovation with its APIs enables a third-party app, such as TikTok or other short video app, to bring customers to a vendor's, such as ebay's, website and keep them with using and incorporating the innovation's personalized feed.

### The APIs

In an embodiment, the platform's APIs serve some underling parts. For the Apps/websites sellers, e.g., vendors such as ebay, Hulu, Verizon, Twitter, and Roku, the innovation is a video portal where such Apps/websites sellers can connect their video, such as illustrated in FIG. 12.

This process can be skipped if the app and/or website already has the video capability where its sellers and/or content publishers post the video. Examples include: (1) when a user gives his/her phone to someone else the innovative platform will be able to understand the user and not show them the ads to make sure there is the highest impact; (2) when a user sees an e-commerce ad within the video they can just tap one time and the product gets checked out as the platform is configured to authenticate the user and complete the e-commerce; and (3) the system is configured to put the ads in live stream based in the users' interest.

In an embodiment, the platform's API goes to the database (e.g., Creator Video Database 421) and extracts the core features from the video, as described in detail above. An example of an extracted core feature is the top the dancer is wearing in FIG. 14A. That is matched (e.g., by API Ad Matching Processor 413) with the current homepage (e.g., as shown in FIG. 12) and with the specific user's interest (e.g., as obtained by User Behavioral Analytics Processor and API 415). Then the platform's API brings those videos on the home page as the summary of the homepage or as a personalized user story. Following are some of these data types: accelerometer and gyroscope data, the pattern of the users when they used their phone in the usual way while performing the activities such as typing, scrolling, calling, chatting, walking, holding, etc., and sends GPS location (latitude, longitude). The platform innovatively identifies the patterns from typing, scrolling, calling, chatting, walking, and holding.

In an embodiment, the API enables videos to feature offers that are available from discount to dynamic pricing, for example, as shown in FIGS. 12-14A. The platform's APIs enables these videos to be clickable.

Another embodiment can be understood with reference to the example as shown in FIGS. 14B-G, screenshots showing how the innovative platform enables the user to view the video and purchase the product shown in the video without ever leaving the video. FIG. 14B is a screenshot of a young man talking, in which he is shown wearing an attractive hoodie. That specific hoodie is available on Amazon and, further, its product information has been processed by the platform, as discussed in embodiments above. Also as discussion in embodiments above, the platform displays the vendor's logo (here, the Amazon logo) in the vicinity (e.g., overlaid on the hoodie) of the hoodie.

FIG. 14C depicts a screenshot of the video about a second further. Here, the user is interested in purchasing that very same hoodie, or is at least interested in learning more about the hoodie product. This situation is depicted by the hand pointer pointing at the Amazon logo to make the selection (e.g., click).

FIG. 14D depicts a screenshot of the video after the Amazon logo has been selected (shown here at second 4). A checkout-type box is displayed. The box lists data that is pertinent about the hoodie and that was either previously stored in the platform's storage or, in another embodiment, is provided in real time by the vendor. In this example, the name of the item and the price are shown in the box. In addition, the platform had been previously been given and stored payment information in the database, as discussion in detail in embodiments above. Thus, the box displays a payment option, that the platform is configured to determine is the preferred payment option, and a checkout button. Here, the hand cursor is over the checkout button, indicating that the user wants to purchase the hoodie (i.e., checkout).

FIG. 14E is a screenshot of the video after the user has clicked the checkout button (shown here still at second 4). In this embodiment and example, the checkout button immediately or after a predetermined amount of time has changed to show the text, Processing, to indicate that the purchase is in progress, but not yet completed.

FIG. 14F is a screenshot of the video after the purchase has been completed (shown here at second 6). In this embodiment and example, the platform indicates that the purchase process is complete by changing the text on the button to display, Thank you!

FIG. 14G is a screenshot of the video after the purchase has been completed, and in which the video continues to stream (shown here at second 7).

Thus, the innovative platform is configured to enable the user to view the video and purchase the product shown in the video without ever leaving the video.

### Use Case

An example of a user journey in an e-commerce site, in accordance with embodiments herein, is as follows:

Sellers (e.g., clothing companies) upload their videos (e.g., to Creator Video Database 421).

These videos are processed by the platform's API (e.g., by Video Analytics Processor with API 412 and stored in Processed Video Database 414).

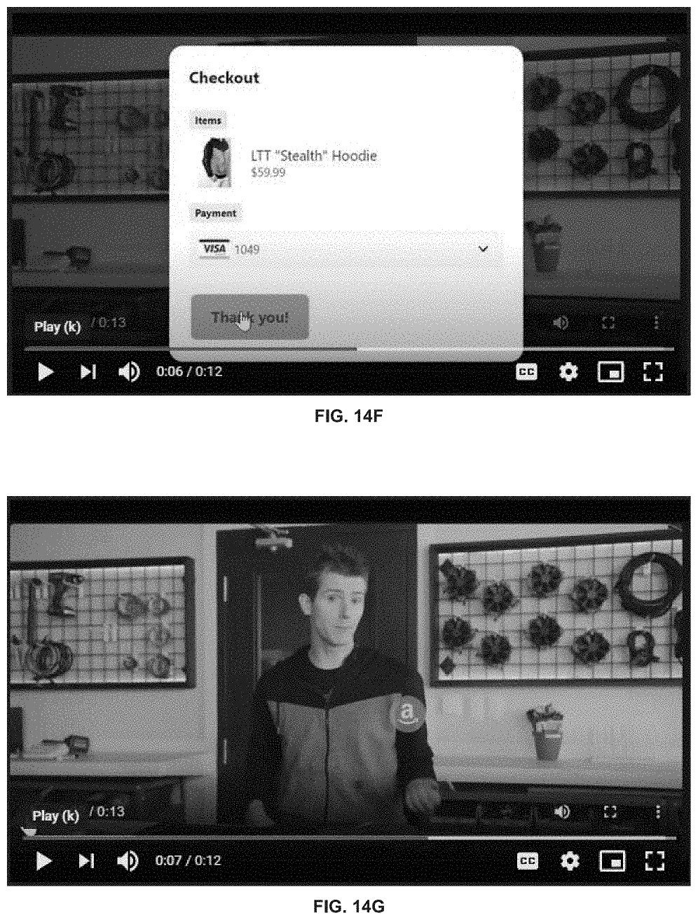

When a regular consumer opens the app/website (e.g., TikTok), 100's of thousands of video had been processed (as shown above) and of that result, the platform determines the top number (e.g., 20) of amount of video that matches (e.g., by API Ad Matching Processor 413) the specific consumer, and such video are presented at the top of the page (e.g., 1202 of FIG. 12). In an embodiment, when a user is watching the 100s of video they like an object they can click and buy the object based on authentication that happened in 1540 of FIG. 15, as described below.

In an embodiment, the user will have the option of viewing each of the presented videos and, from the video, they can see the price and offers of each product through a short, e.g., 5-10 seconds, video. On clicking one of the videos they will be directed, by the platform, to that specific page where they can buy the product.

The APIs innovative transform a website/app from a static page to a dynamic video/consumer-behavior-driven experience. The innovative APIs close the loop; they enable an end-to-end solution for the short video industry, including product discovery through the innovatively ads and e-commerce integration with it.

### Exemplary Embodiments with Continuous User Authentication

In an embodiment, the platform processes continuous authentication of the user on the user's smartphone based on human behavioral patterns using mobile sensors. The innovation eliminates or reduces the requirement of receiving user input, such as typing or biometric input, frequently for user authentication, thereby providing a hassle free experience from the user having to type the password frequently. It has been found that secure private data, even passwords, can leak to the intruders.

Here, again, it should be appreciated that the innovation is a system, method, and/or platform and refers to any of such interchangeably herein (e.g., “system,” “process,” “platform,” or innovation).

The innovation requires continuous authentication to solve the following problems.

One problem with in-video ads is that sometimes the ads get to the wrong user and the innovation is enabling in-video checkout. Hence the need for continuous user authentication, just to make sure that when, for example, the user clicks on the “Shirt” to buy, the system doesn't ask who the user is, etc. The platform ensures an innovatively easy and stream less solution for users and advertisers/sellers.

In one case, the intruder might be lucky (e.g., a side channel attack) and obtains the password of the smartphone; the intruder might then try to pull, gather, or obtain private information from the smartphone. The innovative platform is configured to automatically detect the intruder by using pattern analysis and implementation and restrict him/her from accessing data on the smartphone.

It has been found that frequent user participation is required in biometric authentication. This innovation eliminates or reduces the need for frequent user participation in biometric authentication.

Remote users can access the smartphone with the user's username and password (using certain techniques such as snooping, phishing, or brute force) if the authentication credentials are in digital or text format, however it is almost impossible to mimic users using patterns. The innovative platform processes pattern recognition of user behavior using mobile phone sensor technology for automatic continuous user authentication.

Login-based authentication checks a user's identity only once, at the start of a login session, whereas automatic continuous authentication recognizes the correct user for the duration of ongoing work.

Current login mechanisms use explicit authentication such as passwords, fingerprints, iris scanning, and facial recognition. Therefore, for continuous authentication using traditional mechanisms, the continuous participation from users is required. Such requirement will be annoying and an interruption for users. Therefore traditional authentication methods are not suitable for continuous authentication and the innovative platform does not require or reduces the requirement of such.

Secure passwords are often not considered to be appropriate because they are too lengthy and contain alphanumeric-symbols, which require users to have to spend their precious time in inputting passwords. The innovative platform eliminates or reduces requiring the existence of or the use of such secure passwords.

The user's fingertips often leave a distinguishing trace on the screen, which can indicate the pattern that was used to access the device. The innovative platform eliminates or reduces such distinguishing trace on the screen.

Cyber security specialists suggest not to have a similar password for different accounts, thus it is a tedious task for users to memorize different passwords for each account. The innovation helps reduce this tedious task for users.

### Overview of Methodology and Data Collection

In an embodiment, the platform handles discrete data and, thus, samples continuous data. In an embodiment, the system collects when the system detects motion and at every predetermined number of seconds (e.g., 12 seconds). It has been found that human activity often has frequency less than 20 Hz. That is, for measurement in data from the gyroscope and accelerometer sensors, any data over 20 HZ will mean motion. Thus the platform is configured to choose a sampling frequency that is equal to a predetermined amount (e.g., 50 Hz) to avoid aliasing (e.g., in accordance with Nyquist criteria). In an embodiment, the system collects data over 1 hz to understand micro data for higher authentication.

The smartphone has a number of sensors, such as touchscreen, proximity, magnetometer, accelerometer, gyroscope, GPS, etc. The platform implements the accelerometer, gyroscope, and GPS sensors as a component for authentication, since data gathered from such sensors are independent of environmental factors (e.g., in accordance with the Fischer scoring system). In an embodiment, data can directly go to the cloud or authentication can happen in any part. That is, user data is collected to authenticate them.

The platform is configured with an innovative sensor collecting app that collects activity data from different users. When the user interacts with their phone, the innovative app automatically collects accelerometer, gyroscope and GPS sensor data. The collected data is temporarily stored in the smartphone storage. As soon as enough data is collected, the app automatically uploads such data to the server. In an embodiment, data is pushed every 5 MB at a time. Once the platform analyzes and detects that data in cloud (server) is resulting in the accuracy rate flattening out, then data uploading by the platform stops.

In an embodiment, to develop the innovation, the app was distributed to different users and each user was distinguished using any operating system id (e.g., an Android Device ID). It should be appreciated that other smartphone devices, such as Apple iPhone, etc., can be used, because the system looks into the device id, thus it can be any operating system.

In a field test according to an embodiment, the platform collected data from 15 different users. On average, each user used their phone for about 5 hours a day. The field test included 1500 users for 5 hrs. a day for a month, thus, the total looked into was 225000 hours.

In the field test, users were not explicitly taught or forced to perform specific activities. They used their phone their usual way. For example, the following activities such as typing, scrolling, calling, walking, and holding were frequently performed by the users during data collection.

In accordance with an embodiment, one aim was to find the pattern of the users using sensor data. Thus, the innovative app only required data from when users interacted with their phone. The innovative app ran in background and collected the data only when the user was active.

In an embodiment, GPS data was used.

### An Exemplary Architecture

One or more embodiments of the system architecture can be understood with reference to FIG. 15. Herein, the architecture along with the detailed procedure for the data collection, data pre-processing, filters, and feature selection are described, consistent with embodiments herein. An end user 1502 manipulates a smartphone 1504 that is communicably connected with the platform's server 1506. In an embodiment, end user 1502 is viewer 410 of FIG. 4. Also, smartphone 1504 and its components (described below) reside on frontend 406 of FIG. 4. Also, the components of server 1506 reside on backend 404 of FIG. 4.

In an embodiment, the system contains 4 main components: Server 1506, Smartphone 1504, Rest filter model (1516 and 1534), and innovative user authentication Convolutional Neural Network (CNN) model 1518. There are two different phases: training and testing, in which each phase works separately. That is, in an embodiment, the smartphone is configured to perform two separate processes, a testing phase 1508 and a training phase 1510, described in detail below.

### Training Phase:

In an embodiment, initially, the model is new to the user so it behaves randomly. Therefore, it must be trained with user data. During the training phase, the system continuously monitors and collects sensors (accelerometer and gyroscope) data from the smartphones. One main aim is to find the pattern of the users when they used their phone in the usual way while performing the activities such as typing, scrolling, calling, chatting, walking, holding, etc. Thus, the system collects the data primarily when the user is active. The collected data is temporarily stored in local storage until the data is sufficient for training the model. In an embodiment of the experiment, the size of data was restricted to 5 mb. When stored data reaches up to 5 mb, it automatically uploads to the server. The smartphone also sends GPS location (latitude, longitude) information during uploading to track the user's location. To protect user's privacy each user is identified with their unique id (e.g., android id).

In the server when the raw data is uploaded, it is retrieved from the database and is pre-processed by the rest filter model. The system considers the phone resting on the table as “rest data.” Rest data is invalid for training because such data have no features to distinguish legitimate users from intruders and thus the system removes such rest data. To train the model, the system requires legitimate and intruder data therefore, the training dataset is prepared by merging legitimate data with other participating legitimate user's data at an equal ratio. The innovative user authentication CNN model is trained with the prepared dataset. After training, the models are saved to the database and downloaded to the smartphone.

### Testing Phase:

Once the model is trained, the smartphone is ready for continuous authentication. In the testing phase, the sensors' data are continuously accumulated at 50 Hz. A time-series data from the different channels are segmented with a window of size 200×6. Features are extracted from segmented data and are fed to the rest filter model. Based on the features extracted, the rest filter model identifies the invalid/rest data. Only valid data is further processed. Finally, the innovative user authentication CNN model classifies whether the input data is legitimate or intruder.

To achieve promising results, the platform added some constraints. In an embodiment, the platform classifies the users as legitimate or intruder when the model consistently outputs the same class (legitimate or intruder) a predetermined number of times (e.g., thrice); classified output is considered to be valid by the configured system when the prediction probability is above a predetermined threshold (e.g., 0.8). In an embodiment, the system explicitly uses the advantage of GPS location to track the legitimate user. A predetermined circle of radius (e.g., 1 km), with center as the user's recorded (during training) GPS location (e.g., measured in latitude and longitude) is created where the radius is the threshold that is considered. During testing, if the current GPS location of the user's lies within a circle, the application considers such identification of the location as valid and don't give any penalty to its predicted probability, else the application assigns a penalty of 0.85. Enforcing the penalty improves the robustness of the innovative authentication model because, to overcome the penalty the user is required to have a prediction output greater than a predetermined value (e.g., 0.95.) (i.e., 0.95(prediction probability)*0.85(penalty)=0.8075>0.8 (threshold criteria for classified output to be valid.)

### Data Collection:

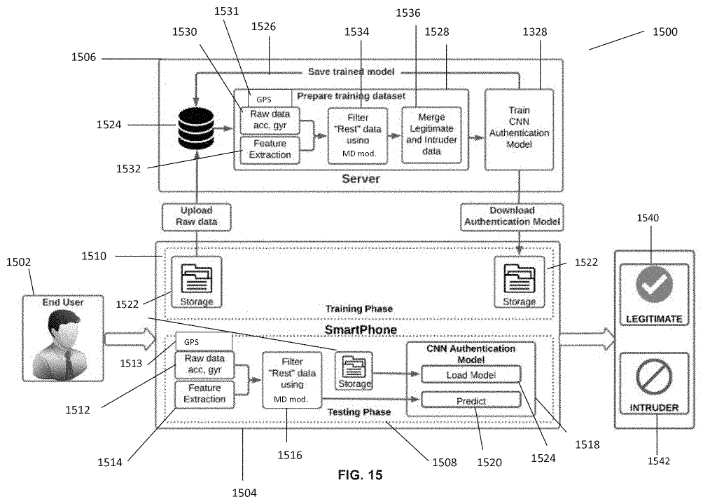

In an embodiment, the innovation's unique user authentication CNN model is based on a supervised machine learning approach. For training the models, a large number of legitimate and intruder user's data are required. Thus, the platform provides a newly built sensor collecting app to collect the data. Smartphones have a number of sensors such as touchscreen, proximity, magnetometer, accelerometer, gyroscope, GPS, etc. As inspired by Implicit Smartphone User Authentication with sensors and Contextual Machine Learning paper, the platform implements the accelerometer, gyroscope, and GPS sensors as a component for authentication, since data gathered from such sensors are independent of environmental factors (e.g., in accordance with the Fischer scoring system). Human activity often has a frequency of less than 20 Hz so, to avoid aliasing the data were collected at a rate of 50 Hz. To carry out the experiment, the innovative app was distributed to 15 different users and each user was distinguished with their android-id. It should be appreciated that other ids could be used, such as ids of other types of mobile devices, to distinguish the users. During a single upload, the platform collects 5 mb of each sensor's data. On average, each user used their phone for about 4 hrs. The users were not explicitly taught or forced to perform any activities. They used their phone in the usual way. During the data collection, activities such as typing, scrolling, calling, walking, holding, chatting were frequently performed. The innovative app runs in the background and collects the data at times when the user is active and interacts with their phone. FIG. 16 is an accelerometer x-axis plot, in accordance with an embodiment. Such plot depicts a graph of the data from the accelerometer's reading of a typical user's handling of their smartphone.

### Filtering the Rest Data:

It has been found that as the raw data from the smartphone sensors consists of only accelerometer and gyroscope values in three directions, they are not good enough for feeding directly to train the machine learning model. Thus, the innovation groups the raw data into the window size of 200 and a different time, as well as frequency domain features, was extracted using the TSFEL library. In an embodiment, the innovation uses the dominant features (listed below under Feature Extraction) for the dataset based on the value of mutual information.

The corresponding Feature Extraction labels were computed by taking the mode of the values within the same window of 200 rows.

After computing the features, the missing values and invalid numbers were replaced by the mean of the corresponding feature. The highly correlated features with Pearson correlation coefficient value greater than 0.95 were also removed. Only one of such features was kept. Also, the features with zero variance were also removed. After selecting the required features, the data were normalized to have zero mean and unit variance so that all the features come to the same scale.

After preprocessing the data, the system fed the data to the training model. The system used the innovative motion detection model, which is a decision tree-based ensemble learning method. The system performed k-fold cross-validation on its dataset with k=5. As the dataset was nearly balanced, the system used accuracy as its metric to evaluate the model.

### PreProcessing and Filters

### Filters:

During the experiment (e.g., field test), different filters (e.g., low, median, and Gaussian) were applied. However, such filters did not appear to improve the performance of the platform or app. The low pass filter eliminated high frequency but, for purposes of the embodiment, high frequency components were important features. Thus, the final implementation did not employ any filters.

### PreProcessing:

Before training the innovative user authentication CNN model, the batch of data is first filtered with the innovative motion detection model/classifier algorithm (e.g., through the ASMI Motion Detection model). The model detects that data is variable and can impact the user authentication. For example, if one's phone is on the table, the innovative motion detection model has no use of that data, but when the model detects moment, the model wants to know if you are “you” or an intruder. Thus, the innovation obtains data that has variability that was filtered by unique motion detection model.
During data collection users might leave their phone alone, e.g., on a table, for a long duration, which results in idle (e.g., invalid) data for the platform's use. An example of what can be a long duration is if there is no moment in the gyroscope or accelerometer for more than 10 seconds, the system marks it as idle and the system doesn't look into the data. Since, during rest condition there is not any significant movement pattern of the users, to incorporate such type of data degrades the performance of the innovation's model. In an embodiment, the platform is filtering data that has no use such as if the phone is charging; then, the platform has no use of that data. If the user falls asleep with the phone in their lap, that data has no use.
Before training, such idle/invalid data is filtered out. Thus, in accordance with an embodiment, the platform used the innovative motion detection model to separate valid and invalid data.
During the experiment, the innovative motion detection model was separately trained with rest (e.g., smartphone on table) and motion (e.g., from users typical manipulation of their smartphones) data and accuracy of 99.99% was achieved. That is, the system trained both with rest data and then without rest data and found that the ultimate identification of the user was within 99.99% accuracy.

Continuing with referring to FIG. 15, in an embodiment, during the testing phase 1508 on the smartphone 1504, raw data are collected by the accelerometer, gyroscope, and GPS sensors (1512 and 1513, respectively). Such data are fed to component 1516, to process the filter rest data using the innovative motion detection model.

In an embodiment, after the raw data are collected, a feature extraction component 1514 performs feature extraction on the data. A list of possible types of feature extracted data, consistent with embodiments herein, are illustrated below. Such data are fed to component 1534, to process the filter rest data using the innovative motion detection model.

### Feature_Extraction

It has been determined that the innovative user authentication CNN model does not require any hand-picked features.
For the innovative motion detection model classifier algorithm (e.g., the rest and motion classifier), the innovation experimented with different features and found following features to be effective:
   ‘Absolute energy’
   ‘Area under the curve’,
   ‘Interquartile range’,
   ‘Kurtosis’,
   ‘Maximum value’,
   Minimum value,
   ‘Mean’,
   ‘Median absolute deviation’,
   ‘Standard deviation’,
   ‘Maximum frequency’,
   ‘Entropy’,
   ‘Negative turning points’,
   ‘ECDF (empirical cumulative distribution function) Percentile along the time axis’,
   ‘Median absolute difference’,
   ‘Spectral distance’,
   ‘Wavelet energy’,
   ‘Wavelet variance’,
   ‘Power spectrum density bandwidth’
Further, the innovation eliminated highly correlated features. One reason they were removed was to make sure they won't affect the weight of total ratio of the data. For example, if two data are almost same: e.g., it's like how many years a person is correlated to how many months that person is. Keeping both data is a waste of time and resources.
TSFEL (time series features extraction library) is used in the Python programming language to extract the require features. In one or more embodiments, time stamp extraction library is also used and for all other languages.

In an embodiment, after feature extraction 1514, the rest data is filtered out using the innovative motion detection model by component 1516. The resulting data are input in the innovative user authentication CNN model 1518, specifically, input into the prediction algorithm 1520. This is the result for the test that happens within the user device. Here the platform predicts if the user is intruder or legitimate. Similarly, from the local storage 1522, the platform causes the model component 1524 to load into the innovative user authentication CNN model 1518 (described in detail below). The model runs in a 90 second time interval. It should be appreciated that FIG. 15 depicts storage 1522 in three different locations for logical purposes. It further should be appreciated that local storage 1522 could represent three different storages, as well.

In an embodiment, once the innovative user authentication CNN model is done, the result comes that either the user is an intruder or a legitimate user. The system runs the model again if the outcome is an intruder to confirm and if the user is an intruder more than three times, then another test happens in server and the user is marked illegitimate. If the user is legitimate then the user is enabled to do perform the above mentioned features (e.g., ASMI features) such as in-video ads, e-commerce, user behavior tracking and targeting.

In an embodiment, the system tests in a timely manner, e.g., every 90 seconds. The system gets constantly updated where system updates on a timely manner.

In an embodiment, during the training phase 1510 of the smartphone 1504, and separate from the testing phase 1508, as the data are collected by components 1512 and 1513, such data are stored in local storage 1522 and then uploaded to the server 1506 into the storage of the server 1524. Such storage also stores the trained model, as shown by arrow 1526.

At the server 1506, and similarly to the smartphone 1504, raw data that had collected by the accelerometer, gyroscope, and GPS components (1512 and 1513, respectively) are fed to a prepare training dataset component 1528. Within such component 1528 is a raw data component 1530 for receiving the accelerometer and gyroscope data, a GPS component 1531 for receiving the GPS data, and a feature extraction component 1532. Such data are fed to component 1534, to process the filter rest data using the innovative motion detection model.

In an embodiment, the feature extraction component 1532 performs feature extraction on the data in the same manner as described above for component 1514. The same list of possible types of feature extracted data shown above apply here, as well, and are consistent with embodiments herein. Such data are fed to component 1534, to process the filter rest data using the innovative motion detection model.

In an embodiment, after feature extraction 1532, the rest data are filtered out using the innovative motion detection model by component 1534.

After the rest data are filtered out, the data are fed to a component 1536 to merge legitimate and intruder data. This process puts the data from verified with unverified to see if the system can draw a pattern in the unverified data. For example, it's similar to if a user wants to understand if a dollar bill verifying machine is working or not will be to mix the verified bill with unverified, then running on a whole bundle to see if the machine is working when the both types of notes are there.

The resulting data of component 1536 is then fed into the training component 1538 to train the innovative user authentication CNN model. The innovative module can understand the various data coming from the user and understand the pattern in it based on the user device and how he or she is interacting. The innovation is about how the system is able to get the data and understand the pattern. Once the authentication model is trained, then the model is downloaded to the smartphone 1504 and, specifically, to the storage 1522 in the smartphone. The system constantly learns from user data and once it is above the par value of 80% confident it will be marked trained.

On an ongoing basis, as the end user 1502 manipulates the smartphone, the smartphone periodically applies the model to the sensor data (from components 1512 and 1513) and determines either that the end user is authenticated (as depicted by icon 1540) or is considered to be an intruder (as depicted by icon 1542). For purposes of understanding herein, manipulating means using the phone. End user 1502 will use the phone and the data goes to the system, component 1520 predicts whether the user is a legitimate user or intruder (1542 or 1540).

### An Exemplary User Authentication Convolutional Neural Network (CNN) Model

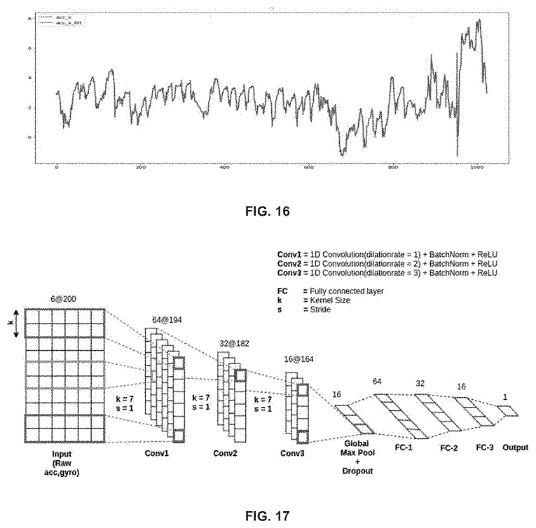

An embodiment can be understood with reference to FIG. 17, an innovative user authentication CNN model architecture. For the authentication, continuously sampled time series data is collected. The platform uses used 1d convolution over the time series data from different channels (acc_x, acc_y, acc_z, gyro_x, gyro_y, gyro_z).

In an embodiment, the model consists of three convolutional blocks, a global max-pooling layer, dropout, and fully connected layers. Each convolutional block consists of 1d convolutional operation, batch normalization, and ReLU activation function. To increase the receptive field and to avoid signal decimation, the innovation has replaced the max-pooling layer with atrous convolution. Grinding effect exits if all the block uses the same dilation rate. Thus, to remove the grinding effect, the innovation has used the dilation rate of (1, 2, and 3) respectively for each convolution. The three convolutional blocks extract abstract representations of the input time-series data.

A summary of the innovative user authentication CNN model is shown below in Table C.

TABLE C

| Layer | | Feature Map | Size | Kernel size | Stride | Activation |
|---|---|---|---|---|---|---|
| Input | Time series data | 6 | 200 | — | — | — |
| 1 | 1 d Convolution + Batch | 64 | 194 | 7 | 1 | ReLU |
| | Normalization | | | | | |
| 2 | 1 d Convolution + Batch | 32 | 182 | 7 | 1 | ReLU |
| | Normalization | | | | | |
| 3 | 1 d Convolution + Batch | 16 | 164 | 7 | 1 | ReLU |
| | Normalization | | | | | |
| 4 | Global Max Pooling + Dropout | — | 16 | 164 | — | ReLU |
| 5 | Fully Connected + Batch | — | 64 | — | — | ReLU |
| | Normalization | | | | | |
| 6 | Fully Connected + Batch | — | 32 | — | — | ReLU |
| | Normalization | | | | | |
| 7 | Fully Connected + Batch | — | 16 | — | — | ReLU |
| | Normalization | | | | | |
| Output | Fully Connected | — | 1 | — | — | Sigmoid |

### Results and Discussion:

In an embodiment of the system, two models were used. One is the Innovative motion detection model for filtering out rest data and another model is based on convolutional neural network which is used for authentication.

For the task of filtering rest data, the innovation experimented with different machine learning models such as Logistic regression, Random Forest, and Support Vector Machine (SVM) and the Innovative motion detection model. While comparing the result of K-fold cross validation of different models, it was found that the Innovative motion detection model performed best in some use cases. The innovative motion detection model gave 99.99% accuracy on the dataset. Because the rest data consists mostly of nearly constant values, detecting rest data was easy for the Innovative motion detection model.

For the task of authentication, the innovation compared the result of both machine learning as well as deep learning based methods. It was found that the machine learning models such as the innovative motion detection model, Random Forest, and SVM performed better than deep learning based methods when the training dataset was small. However, as the size of the training dataset increased, the innovative user authentication model based on Convolutional Neural Network (CNN) outperformed the result of machine learning based methods. Thus, embodiments consistent herein use the innovation user authentication CNN model for authentication, which obtained an accuracy of 94% on the dataset.

Table D shows the innovative motion detection model classifier rest filter model classification accuracy, in accordance with embodiments herein.

TABLE D

| class | precision | recall | f1-score | support |
|---|---|---|---|---|
| motion | 1 | 1 | 1 | 16292 |
| rest(in table) | 1 | 1 | 1 | 12922 |
| accuracy | | | 0.999 | 29214 |

Although the invention is described herein in terms of several embodiments, one skilled in the art will readily appreciate that other applications may be substituted for those set forth herein without departing from the spirit and scope of the present invention. Accordingly, the invention should only be limited by the Claims included below.

1. A system, comprising:
a smartphone, wherein the smartphone comprises: an accelerometer sensor, a gyroscope sensor, and a GPS sensor, wherein each sensor collects raw data from manipulations of the smartphone for purposes of user authentication;
a rest filter model configured to receive the raw data and configured to process the raw data using a motion detection module to identify valid data and invalid data therefrom, wherein valid data is data reflecting motion of the smartphone and invalid data is data reflecting the smartphone at rest;
a user authentication convolutional neural network (“CNN”) model configured to receive the identified valid and invalid data and generate a prediction that the manipulations of the smartphone are from a legitimate user or from an intruder; and
a server configured to train and store the user authentication CNN model and further configured to download the trained user authentication CNN model to the smartphone on a predetermined time basis.

2. The system of claim 1, wherein the system is configured to process a testing phase and a training phase, and when the user authentication CNN model is trained, the smartphone is configured to perform continuous user authentication.

3. The system of claim 1, wherein raw data reflects typical activities including typing, scrolling, calling, chatting, walking, holding, and location, and the user authentication CNN model determines one or more patterns of typical behavior for a user, based on the raw data reflects typical activities.

4. The system of claim 1, wherein said system is a component of a network-accessible platform that enables in-video product purchasing and wherein the system is configured to provide automatic user authentication is response to a request for purchasing an in-video product.

5. The system of claim 1, wherein the user authentication CNN model is trained on an on-going basis.

6. The system of claim 1, wherein the smartphone is configured to collect the raw data in local storage up to 5 mb and when over 5 mb, the smartphone automatically uploads the raw data to the server for training the user authentication CNN model and the smartphone is configured to send the GPS location data to the server along with the raw data.

7. The system of claim 1, wherein the sensors are configured to, at testing phase, continuously accumulate data at 50 Hz.

8. The system of claim 1, wherein the smartphone further comprises a feature extraction component that is configured to extract features from the data and feed such extracted features to the rest filter model and wherein the rest filter model is further configured to receive the extracted features and use the features for identifying the invalid data and further configured to send the valid data to the user authentication CNN model.

9. The system of claim 8, wherein the features comprise:
absolute energy;
area under the curve;
interquartile range;
kurtosis;
maximum value;
minimum value;
mean;
median absolute deviation;
standard deviation;
maximum frequency;
entropy;
negative turning points;
ECDF (empirical cumulative distribution function) Percentile along the time axis;
median absolute difference;
spectral distance;
wavelet energy;
wavelet variance; and
power spectrum density bandwidth.

10. The system of claim 1, wherein the user authentication CNN model is configured to classify a user as legitimate or intruder when the model consistently outputs the same class (legitimate or intruder) thrice and the classified output is considered to be valid when the prediction probability is above 0.8.

11. The system of claim 1 is further configured to use GPS to track a legitimate user by using a predetermined circle of radius, with center as the user's recorded, during training, GPS location, that created, wherein the radius is the threshold that is considered and wherein during testing, if the current GPS location of the user's lies within a circle, the identification of the location is determined valid and no penalty is given to its predicted probability, else the application assigns a penalty of 0.85, wherein enforcing the penalty improves the robustness of the innovative user authentication CNN model because, to overcome the penalty the user is required to have a prediction output greater than a predetermined value.

12. The system of claim 1, wherein the smartphone is configured to push data to the server every 5 mb at a time and wherein the server is configured so that once the uploaded data achieves an accuracy rate that is flattening out, the data uploading stops.

13. The system of claim 1, wherein the smartphone is configured to collect data when the smartphone detects motion and at every 12 seconds.

14. The system of claim 1, wherein the user authentication CNN model runs in a 90 second time interval.

15. The system of claim 1, wherein the user authentication CNN model is configured to constantly learn from user data by being configured to determine that once a measurement of confidence is above a par value of 80%, then the model is considered confident is marked trained.

16. The system of claim 1, wherein when a user is watching a plurality of videos and they like an object on a particular video, the user is enabled to click and buy the object based on the user authentication CNN model producing a output that indicates that the user is legitimate.

17. The system of claim 1, wherein the system is further configured to run the user authentication CNN model again if the user is classified as an intruder to confirm and if the user is classified as an intruder more than three times, then another test is performed in server and the user is marked illegitimate.

18. The system of claim 1, wherein when there is no moment in the gyroscope or accelerometer sensors for more than 10 seconds, the smartphone is marked as idle and the data are not further processed.

19. A method, comprising:
collecting raw data from manipulations of a smartphone for purposes of user authentication, wherein the smartphone comprises: an accelerometer sensor, a gyroscope sensor, and a GPS sensor, for collecting the data;
receiving, at a rest filter model, the raw data and processing the raw data using a motion detection module to identify valid data and invalid data therefrom, wherein valid data is data reflecting motion of the smartphone and invalid data is data reflecting the smartphone at rest;
receiving, by a user authentication convolutional neural network (“CNN”) model, the identified valid and invalid data and generating therefrom a prediction that the manipulations of the smartphone are from a legitimate user or from an intruder; and
training and storing, by a server, the user authentication CNN model and downloading the trained user authentication CNN model to the smartphone on a predetermined time basis.

20. A non-transitory computer readable medium having stored thereon instructions which, when executed by a processor, performs the steps of:
collecting raw data from manipulations of a smartphone for purposes of user authentication, wherein the smartphone comprises: an accelerometer sensor, a gyroscope sensor, and a GPS sensor, for collecting the data;
receiving, at a rest filter model, the raw data and processing the raw data using a motion detection module to identify valid data and invalid data therefrom, wherein valid data is data reflecting motion of the smartphone and invalid data is data reflecting the smartphone at rest;
receiving, by a user authentication convolutional neural network (“CNN”) model, the identified valid and invalid data and generating therefrom a prediction that the manipulations of the smartphone are from a legitimate user or from an intruder; and
training and storing, by a server, the user authentication CNN model and downloading the trained user authentication CNN model to the smartphone on a predetermined time basis.
